(19) United States
(12) Patent Application Publication
(10) Pub. No.: US 2013/0132819 A1
(43) Pub. Date: May 23, 2013

(54) STORAGE OF HTML FORM DATA IN AN HTML FILE

(71) Applicants: Hongbing ZHOU, Beijing (CN); Nan FAN, Beijing (CN); Ye WANG, Beijing (CN); Chenxin SUN, Beijing (CN)

(72) Inventors: Hongbing ZHOU, Beijing (CN); Nan FAN, Beijing (CN); Ye WANG, Beijing (CN); Chenxin SUN, Beijing (CN)

(73) Assignee: ADOBE SYSTEMS INCORPORATED, SAN JOSE, CA (US)

(21) Appl. No.: 13/191,010

(22) Filed: Jul. 26, 2011

(51) Int. Cl. G06F 17/00

(52) U.S. Cl. 715/234

(57) ABSTRACT

Techniques to encode data for a form in a HTML file and store the data for the HTML form along with the form itself are described. In one approach, script is injected into an HTML file at a client device. The HTML file may be configured to define at least one HTML form. The script injected into the HTML file is operable to encode input values entered into fields of the form with a data exchange standardization format to generate encoded input values and store the values in the HTML file. When the form is rendered, the script is further operable to decode the input values and populate the form with the values.

### BACKGROUND

1. Field

This disclosure generally relates to data storage. More particularly, the disclosure relates to storage of HTML form data.

2. General Background

A form is a typical document that is utilized by a user to input data on a computing device. The form may be in the format of HTML. The HTML form data is typically stored in an Extensible Markup Language (“XML”) file or in a database. In other words, the data entered into the form may be stored in a separate location than the form itself. As a result, difficulties may arise. For example, the form data may be lost. As a result, the user may have access to the stored form, but without the saved data. Alternatively, the form itself may be lost even though the user may have access to the saved form data. Further, the form may change in that separate location. As a result, the data may no longer be compatible with the form. As an example, if a form has a particular field in which data is inputted and the form is changed to remove that field, rendering of the modified form in one location with data in another location may not function properly.

In addition, current forms are limited to online data submission. The form data is separated from the textual content. Accordingly, current HTML forms do not allow for offline editing.

Certain types of forms also do not allow textual content and user input data to be stored separately, but on the same device and transported together so that the form and content data always stay together. For example, PDF forms that are run on mobile devices currently do not allow such separation. As a result, difficulties may occur when editing and submitting PDF forms on mobile devices.

### SUMMARY

In one aspect of the disclosure, a computer program product is provided. The computer program product includes a computer useable medium having a computer readable program. The computer readable program when executed on a computer causes the computer to add a set of code to an HTML file. The HTML file has at least one HTML form. Further, the computer readable program when executed on the computer causes the computer to identify, with the set of code, an input value in the at least one HTML form. In addition, the computer readable program when executed on the computer causes the computer to encode, by utilizing a processor, the input value with a data exchange standardization format to generate an encoded input value. The computer readable program when executed on the computer causes the computer to store the encoded input value and the set of code in the HTML file such that the set of code decodes the encoded input value and populates the at least one HTML form with the input value.

In another aspect of the disclosure, a process is provided. The process adds a set of code to an HTML file, the HTML file having at least one HTML form. Further, the process identifies, with the set of code, an input value in the at least one HTML form. In addition, the process encodes, by utilizing a processor, the input value with a data exchange standardization format to generate an encoded input value. The process also stores the encoded input value and the set of code in the HTML file such that set of code decodes the encoded input value and populates the at least one HTML form with the input value.

In yet another aspect of the disclosure, a system is provided. The system includes a processor that adds a set of code to an HTML file such that the set of code identifies an input value in at least one HTML form in the HTML file and encodes the input value with a data exchange standardization format to generate an encoded input value. Further, the system includes a storage device that stores the encoded input value and the set of code in the HTML file such that the set of code decodes the encoded input value and populates the at least one HTML form with the input value.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates an HTML storage and rendering configuration.

FIG. 2A illustrates an application for life insurance form, which is an example of the form illustrated in FIG. 1.

FIG. 2B illustrates the application for life insurance form illustrated in FIG. 2A and user input that has been inputted in the application for life insurance form.

FIG. 3 illustrates a process that may be utilized to store HTML form input data into an HTML document.

FIG. 4 illustrates a system configuration that may be utilized for storage and rendering of HTML form data in an HTML document.

### DETAILED DESCRIPTION

An HTML data storage configuration is provided that allows for HTML data to be stored in the HTML file itself. For example, both form textual content, i.e., form itself, and user input data may be stored in a single file, which treats HTML as a document. Accordingly, the HTML file can be opened by different applications in contrast with current browser configurations in which the save operation does not save user input data into the HTML file. Further, edits and submission of particular forms, e.g., PDF forms, are supported as a result of textual content and user input data being stored in the same file to keep display content and data consistent. In addition, the HTML form functionality is extended to support offline editing. This approach may be implemented as a green solution without extra local storage. Further, when new forms/HTML files are added, no work or very limited work has to be performed, which provides a benefit to a user.

In addition, data exchange amongst different types of forms may be implemented. As an example, data exchanged across HTML forms and PDF forms may be utilized. In addition, existing forms may be utilized with the configurations provided for herein so that the forms themselves do not have to be modified.

A variety of input fields may be utilized in an HTML document such as a radio button, a checkbox, a text field, a text area, a select, or the like. In one embodiment, the HTML configuration may generically identify input fields in the HTML form, gather an input value, encode the input value with a data exchange standardization format and pass the encoded data to a data store program to store data back to the HTML file itself. The data exchange standardization format may be JavaScript Object Notation (“JSON”), XML, or the like. Further, an example of the data store program is Action Script. The data stored may be in a hidden component in the HTML form or in the input fields themselves.

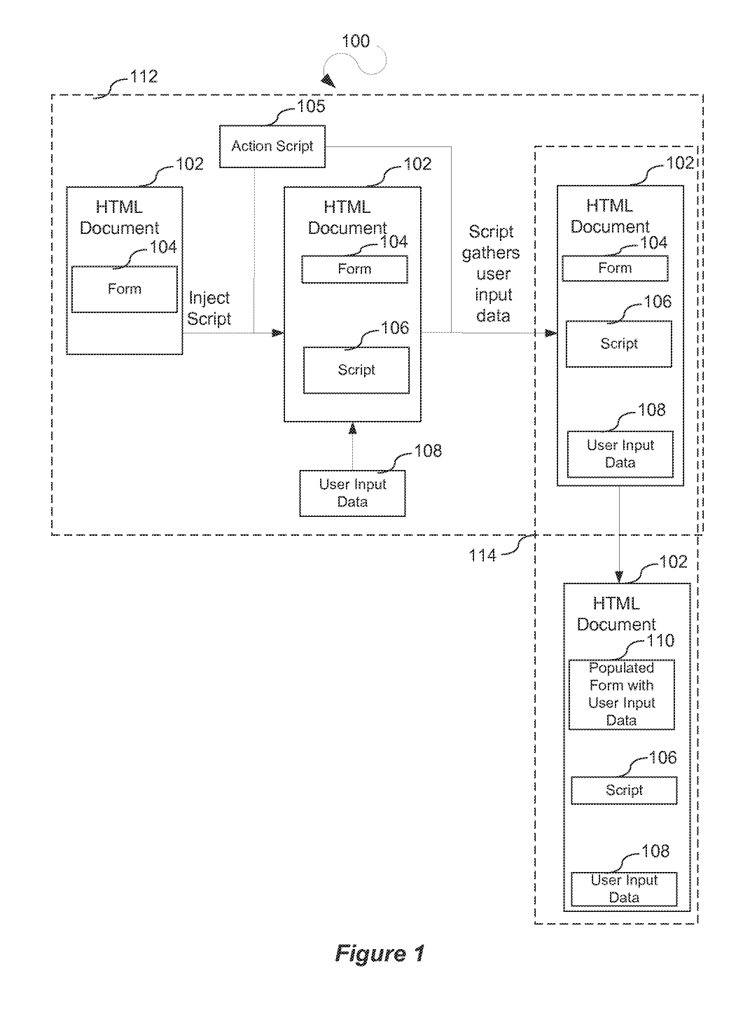

FIG. 1 illustrates an HTML storage and rendering configuration 100. The HTML storage and rendering configuration 100 includes a storage phase 112 and a rendering phase 114. The storage phase 112 begins with an HTML document 102 that has a form 104. The form 104 may be an HTML form. The storage phase 112 injects a script 106 into the HTML document 102. In one embodiment, the script 106 is a client-based script that performs certain actions on a client device. Accordingly, the HTML document 102 may store the script 106. Further, the HTML document 102 may receive user input data 108. The script 106 identifies the input fields in the form 104 and retrieves the user input data inputted into those input fields. Further, the script 106 may encode the retrieved user input data according to a data exchange standardization format such as JSON, XML, or the like. For example, the user input data from the input fields in the form 104 may be encoded as a JSON string. In one embodiment, the encoded user input data is sent by the script 106 to an action script 105 that may store the encoded user input data in the location of the HTML document 102. The script 106 may be utilized to render and gather data. Storage of the data may be performed by an action script 105. The action script 105 performs the storage of the data via a unique identification of input data. In one embodiment, the action script 105 injects the user input data 108 into the HTML document 102. The script 106 is utilized to gather the user input data 108 and pass the user input data 108 to the script 105 in the data gathering and storage process. Further, a method in the script 106 may be utilized to gather data from the form 104 and pass that data back to the action script 105. Further, the action script 105 may store the encoded user input data back into the HTML document 102. As an example, an ActionScript method may call a generic method saveFormDataToHTML. The form name and the file name are known by the client device. Alternatively, the form name may be automatically detected by the script 106 itself. Accordingly, the form name and the file name may be passed as parameters to the generic method saveFormDataToHTML to save the encoded user input data into the HTML document 102.

An overlap may exist between the storage phase 112 and the render phase 114. The render phase utilizes the HTML document 102 that has the form 104, the script 106, and the user input data 108 stored in the HTML document. To render the HTML document 102 with the user input data 108 stored in the HTML document 102, the script 106 may call a generic method at display time. For example, the script 106 may call a generic JavaScript method called renderFormData( ). The method may also be called by the action script 105. This method reads data into the input fields. For example, the method may read the user input data into radio buttons, checkboxes, text boxes, text areas, select fields, or the like.

Although the script 106 is illustrated, a variety of other scripts may be utilized. As an example, a script may be utilized for storage and a separate script may be utilized for rendering. Further, although the script 106 has been described as calling methods or functions to provide certain functionality, the script 106, or other scripts, may itself perform that functionality without having to call methods or functions.

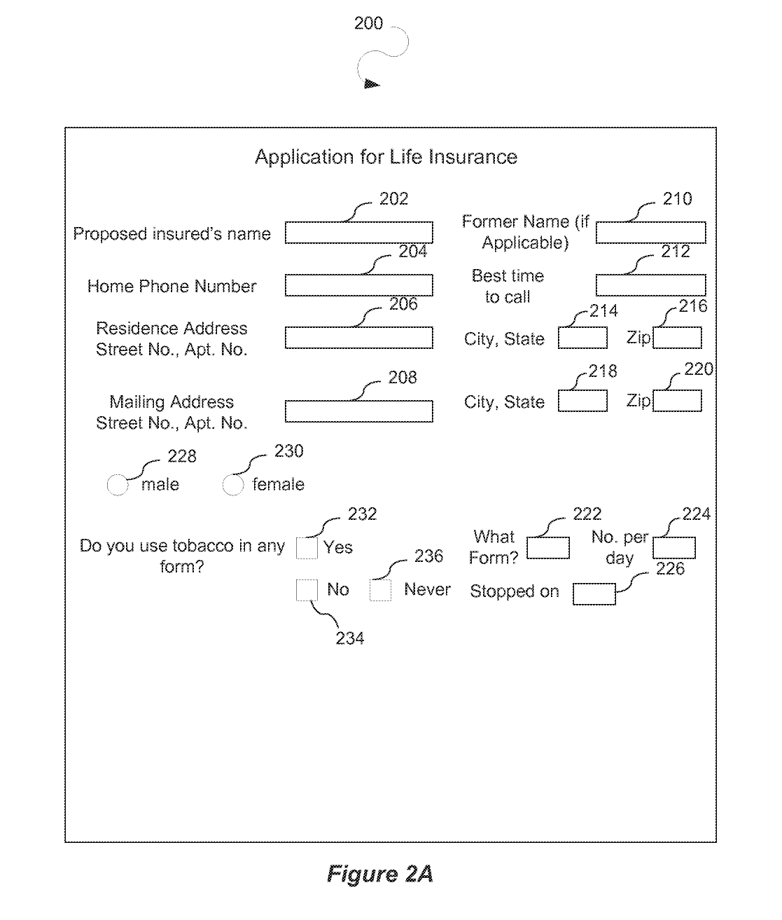

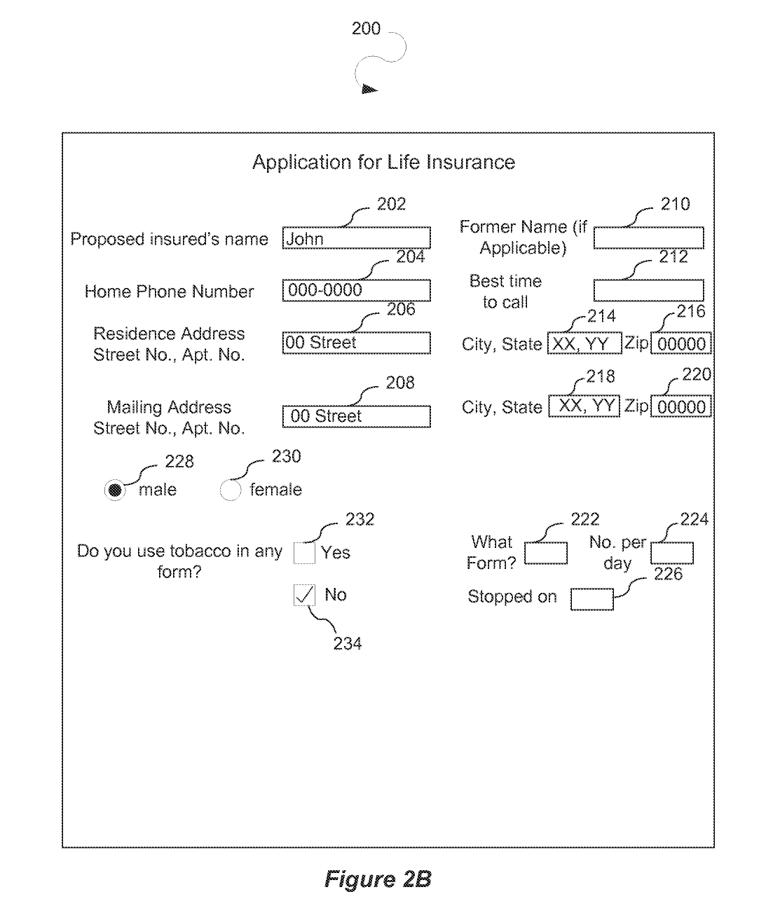

FIG. 2A illustrates an application for life insurance form 200, which is an example of the form 104 illustrated in FIG. 1. The application for life insurance form 200 is an HTML form with various types of input fields. For the example, the application for life insurance form 200 may have text box fields for information regarding an applicant for life insurance such as a proposed insured's name field 202, a home phone number field 204, a residence address 206 field, a mailing address field 208, a former name field 210, a best time to call field 212, a residence address city and state field 214, a residence zip code field 216, a mailing address city and state field 218, and a mailing address zip code field 220. Information can be typed into each of these boxes. Further, the application for life insurance form 200 may have text box fields for information regarding the user of tobacco such as a what form field 222, a number per day field 224, and a stopped on field 226. Information may also be typed into these boxes. The application for life insurance form 200 also has radio button fields such as a male radio button field 228 and a female radio button field 230. A user may click in one of these radio button fields to select the gender of the applicant. Further, the application for life insurance form 200 also has checkboxes such as a yes checkbox 232, and a no checkbox 234. A user may click on one of these checkboxes to make a selection to answer the question of whether the life insurance applicant uses tobacco in any form.

The fields illustrated in FIG. 2A are provided merely as examples. A variety of other types of fields may be utilized in an HTML form.

FIG. 2B illustrates the application for life insurance form 200 illustrated in FIG. 2A and user input that has been inputted in the application for life insurance form 200. For example, information regarding the life insurance applicant is entered into particular text fields such as the proposed insured's name field 202, the home phone number field 204, the residence address 206 field, the mailing address field 208, the residence address city and state field 214, the residence zip code field 216, the mailing address city and state field 218, and the mailing address zip code field 220. Further, the male radio button field 228 is selected. In addition, the no checkbox 234 is selected. All of the text inputs, radio button selections, and checkbox selections comprise the user input data. Other types of selections may also comprise user input data, but these selections are utilized for illustrative purposes. Accordingly, the use input data is encoded according to a data exchange standardization format. The HTML form is then stored as part of the HTML document and the encoded user input data is stored back within the HTML document. As the HTML form and the user input data are stored together in a single file, a user may enter the user input data in the HTML form offline prior to online submission. When the user would like to go online and submit the completed form, the form can be rendered with the user input data and be submitted to an entity that reviews the form. As an example, a user may enter the life insurance application information into the application for life insurance 200 on a portable device that is not online. The user may then save the user input data into the same file and then submit the form populated with the user input data after rendering to the life insurance company to apply for life insurance.

In one embodiment, the rendering process involves a decoding of the user input data that was encoded according to the data exchange standardization format. By having a data exchange standardization format, all of the field inputs can be encoded according to the same format to allow for simpler and faster decoding. For example, different fields, e.g., text fields, radio button fields, etc., may be identified, but encoded according to the same format so that all of the user input data can be easily rendered in the HTML form.

The user input data may either be stored directly in the input fields or in a hidden component. For example, the proposed insured's name may be stored directly in the proposed insured's name field 202 or stored in a hidden component such as a <div> element. The <div> element is a block-level element of an HTML document that is utilized for a part of an HTML document that cannot be semantically described by other HTML elements. Further, an indicator may be utilized to identify the location of where the user input data is stored in the HTML file. As an example, the form name and a specific tag may be utilized as an indicator. However, this indicator is just an example as various other indicators may be utilized.

As an example, a user such as an insurance salesperson may synchronize forms, including HTML forms, to a portable device such as a smartphone, tablet, or the like. The user can then utilize the form to collect data while he or she is visiting his or her customer and save the data locally, e.g., the user input data to HTML file itself. When the user goes back to his or her office and connects to a server, he or she can submit the HTML form and user input data as a single file to a server, or only submit the data back to the server, so that the insurance application may be processed. Accordingly, traffic may be minimized between the server and the client. The data retrieval is performed by the action script 105 as the action script 105 handles the document without additional display of the HTML file.

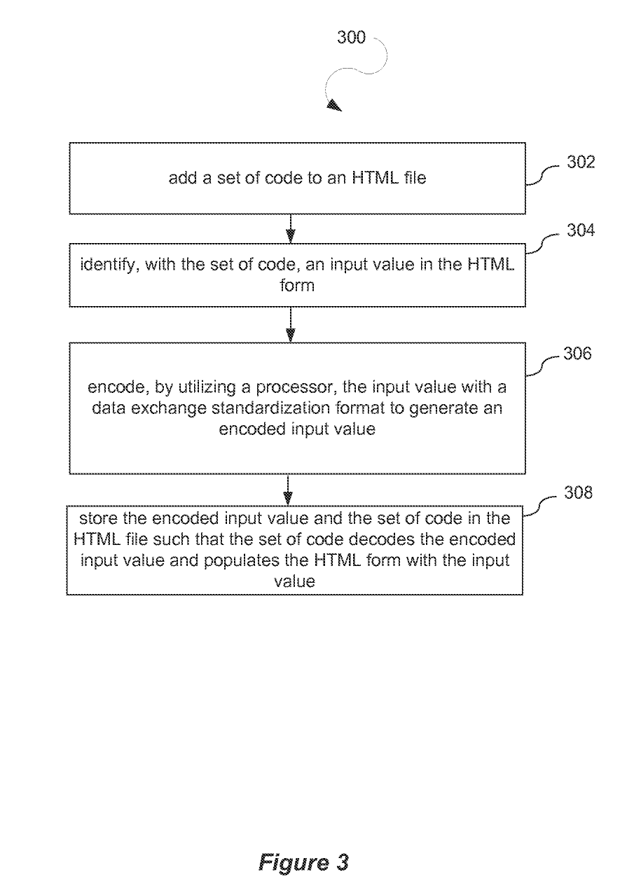

FIG. 3 illustrates a process 300 that may be utilized to store HTML form input data into an HTML document. At a process block 302, the process 300 adds a set of code to an HTML file, the HTML file having an HTML form. Further, at a process block 304, the process 300 identifies, with the set of code, an input value in the HTML form. In addition, at a process block 306, the process 300 encodes, by utilizing a processor, the input value with a data exchange standardization format to generate an encoded input value. At a process block 308, the process 300 stores the encoded input value and the set of code in the HTML file such that set of code decodes the encoded input value and populates the HTML form with the input value. The same set of code or different sets of code may be utilized to perform the various functions of the process 300. For example, the same set of code may perform both the encoding and the decoding, or a first set of code may perform the encoding and a second set of code may perform the decoding. In one embodiment, the set of code is a client-based script. In another embodiment, the set of code automatically populates the HTML form with the user input data stored within the HTML document. In yet another embodiment, the set of code populates the HTML form with the user input data stored within the HTML document upon receiving a manual command.

Any of the configurations described herein may be utilized with a variety of document formats. For example, the methodologies described herein may be utilized for other types of documents besides HTML documents.

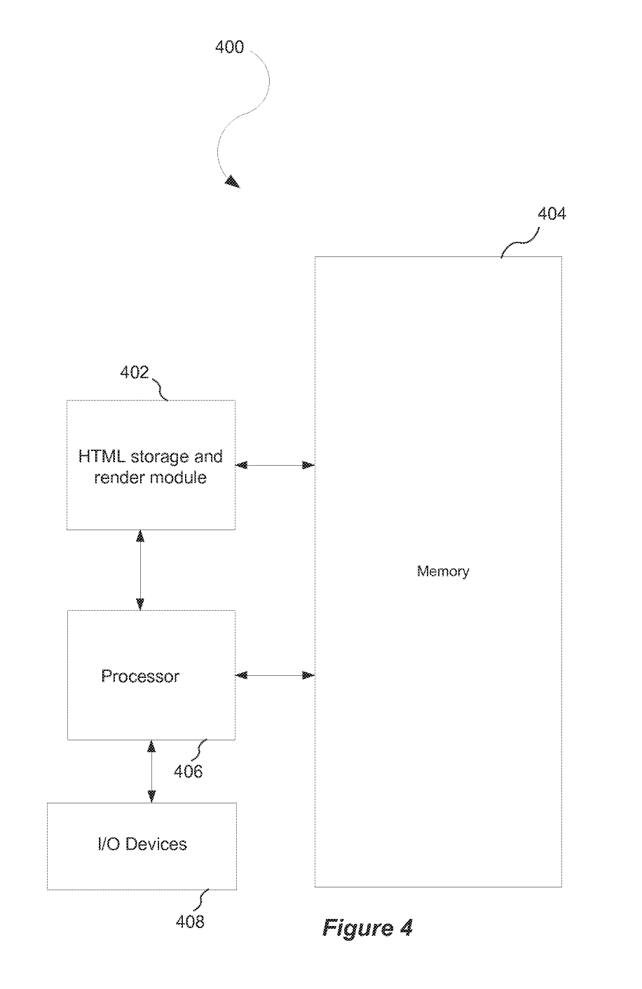

FIG. 4 illustrates a system configuration 400 that may be utilized for storage and rendering of HTML form data in an HTML document. In one embodiment, an HTML storage and render module interacts with a memory 404 and a processor 406. In one embodiment, the system configuration 400 is suitable for storing and/or executing program code and is implemented using a general purpose computer or any other hardware equivalents. The processor 406 is coupled, either directly or indirectly, to the memory 404 through a system bus. The memory 404 can include local memory employed during actual execution of the program code, bulk storage, and/or cache memories which provide temporary storage of at least some program code in order to reduce the number of times code must be retrieved from bulk storage during execution.

The Input/Output (“I/O”) devices 408 can be coupled directly to the system configuration 400 or through intervening input/output controllers. Further, the I/O devices 408 may include a keyboard, a keypad, a mouse, a microphone for capturing speech commands, a pointing device, and other user input devices that will be recognized by one of ordinary skill in the art. Further, the I/O devices 408 may include output devices such as a printer, display screen, or the like. Further, the I/O devices 408 may include a receiver, transmitter, speaker, display, image capture sensor, biometric sensor, etc. In addition, the I/O devices 408 may include storage devices such as a tape drive, floppy drive, hard disk drive, compact disk (“CD”) drive, etc. Any of the modules described herein may be single monolithic modules or modules with functionality distributed in a cloud computing infrastructure utilizing parallel and/or pipeline processing.

Although a single form has been illustrated, multiple forms in single HTML file may be utilized with any of the configurations provided for herein. Since the data may include unique identification, such as form name and/or other unique identifying information, multiple forms may be stored in the same HTML file. Alternatively, multiple forms may be stored in separate HTML files. Network adapters may also be coupled to the system configuration 400 to enable the system configuration 400 to become coupled to other systems, remote printers, or storage devices through intervening private or public networks. Modems, cable modems, and Ethernet cards are just a few of the currently available types of network adapters.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

It should be understood that the processes and systems described herein can take the form of entirely hardware embodiments, entirely software embodiments, or embodiments containing both hardware and software elements. If software is utilized to implement the method or system, the software can include but is not limited to firmware, resident software, microcode, etc.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes, systems, and computer program products. Therefore, it is to be understood that, within the scope of the appended claims, the present processes, systems, and computer program products may be practiced other than as specifically described herein.

1. A computer readable memory storing a computer readable program, wherein the computer readable program when executed on a client device causes the client device to:
inject a script into an HTML file obtained for rendering by the client device, the HTML file having at least one HTML form, the script configured to cause the client device to perform actions to store user input values entered for fields of the HTML form in the HTML file along with the HTML form;
identify, with the script, an input value in the at least one HTML form;
encode, by utilizing a processor, the input value with a data exchange standardization format to generate an encoded input value; and
store the encoded input value and the script in the HTML file such that the script decodes the encoded input value and populates the at least one HTML form with the input value when the HTML is rendered.

2. The computer readable memory of claim 1, wherein the encoded input value is stored in an input field of the HTML file, the input field corresponding to a location of where the input value was inputted in the at least one HTML form.

3. The computer readable memory of claim 1, wherein the encoded input value is stored in a hidden location of the HTML file.

4. The computer readable memory of claim 1, wherein the computer readable program when executed on the client device further causes the client device to generate an indicator of a location of the encoded input value in the HTML file.

5. The computer readable memory of claim 4, wherein the indicator includes a name of the at least one HTML form and a tag.

6. The computer readable memory of claim 1, wherein the script is a client-based script.

7. The computer readable memory of claim 1, wherein the script populating the at least one HTML form with the input value is performed automatically.

8. A method comprising:
obtaining a HTML file for rendering by a client device;
injecting a script into the HTML file, the HTML file having at least one HTML form, the script configured to cause the client device to store user input values entered for fields of the HTML form in the HTML file with the HTML form;
identifying, with the script, an input value in the at least one HTML form;
encoding, by utilizing a processor, the input value with a data exchange standardization format to generate an encoded input value; and
storing the encoded input value and the script in the HTML file such that the script decodes the encoded input value and populates the at least one HTML form with the input value.

9. The method of claim 8, wherein the encoded input value is stored in an input field of the HTML file, the input field corresponding to a location of where the input value was inputted in the at least one HTML form.

10. The method of claim 8, wherein the encoded input value is stored in a hidden location of the HTML file.

11. The method of claim 8, further comprising generating an indicator of a location of the encoded input value in the HTML file.

12. The method of claim 11, wherein the indicator includes a name of the at least one HTML form and a tag.

13. The method of claim 8, wherein the script is a client-based script.

14. The method of claim 8, wherein the script populating the at least one HTML form with the input value is performed automatically.

15. A system comprising:
a processor that injects a script into an HTML file obtained for rendering at the system, such that the script identifies an input value in at least one HTML form in the HTML file and encodes the input value with a data exchange standardization format to generate an encoded input value; and
a storage device that stores the encoded input value and the script in the HTML file such that the script is operable upon rendering of the HTML file to decode the encoded input value and populate the at least one HTML form with the input value.

16. The system of claim 15, wherein the encoded input value is stored in an input field of the HTML file, the input field corresponding to a location of where the input value was inputted in the at least one HTML form.

17. The system of claim 15, wherein the encoded input value is stored in a hidden location of the HTML file.

18. The system of claim 15, wherein the processor also generates an indicator of a location of the encoded input value in the HTML file.

19. The system of claim 18, wherein the script is a client-based script.

20. The system of claim 15, wherein the script populating the at least one HTML form with the input value is performed automatically.
